(19) United States
(12) Patent Application Publication
(10) Pub. No.: US 2026/0043461 A1
(43) Pub. Date: Feb. 12, 2026

(54) SPINDLE DRIVE

(71) Applicant: Stabilus GmbH, Koblenz (DE)

(72) Inventors: Markus Reifenhäuser, Niederhofen (DE); Sebastian Schimmelpfennig, Bad Neuenahr - Ahrweiler (DE)

(21) Appl. No.: 19/285,664

(22) Filed: Jul. 30, 2025

(30) Foreign Application Priority Data
Aug. 7, 2024 (DE) 102024122579.3

(51) Int. Cl. F16H 25/24; B60J 5/04; E05F 15/63; F16H 25/20

(52) U.S. Cl. CPC F16H 25/2454; E05F 15/63; B60J 5/047; E05Y 2201/696; E05Y 2900/531; F16H 2025/2031; F16H 2025/2084; F16H 2025/209

(57) ABSTRACT

The present invention relates to a spindle drive (10) comprising a drive unit (12), a spindle (34), a housing unit (20) fixedly coupled to the drive unit (12), a bearing cage (28) which is accommodated within the housing unit (20) and is pivotable about a predetermined angular range with respect to a pivot axis, and a spindle nut (30) which is mounted at a fixed angle in the bearing cage (28) and is in threaded engagement with the spindle (34), wherein the spindle nut (30) can be driven in rotation by the drive unit (12) via a transmission arrangement (18).

### DESCRIPTION

The present invention relates to a spindle drive comprising a drive unit, a spindle, and a spindle nut in threaded engagement with the spindle, and to a door arrangement for a vehicle comprising such a spindle drive.

A typical application for spindle drives, which are generally used in various fields to move an element relative to another element in a motorized manner, is to operate doors or panels of vehicles. Due to the pivoting movements of such elements relative to the vehicle body, such automatic operation of doors and panels, in particular trunk hatches, of a vehicle requires a design of a spindle drive which is able to cope with such a pivoting movement. For this purpose, sometimes quite complex spindle drives were used, which were mounted on the vehicle door or vehicle panel on the one side, and on the vehicle body on the other side, in order to be able to follow all movements of the panel or door. However, such complex mountings for spindle drives require corresponding installation space and can be costly and maintenance-intensive.

Although a spindle drive according to the invention will be described below mainly with respect to the mentioned possible intended use in a vehicle, it is understood that corresponding spindle drives can also be used in various other fields and scenarios in which comparable kinematics are required.

In the prior art, for example from DE 10 2017 204 914 A1, a spindle drive is known in which a spindle is driven, a connecting element being pivotably mounted on a spindle nut which is in threaded engagement with the spindle, which connecting element is designed, for example, for connection to a panel. However, the apparatus described therein has the disadvantage that it requires an additional and relatively complex connecting element between the spindle nut and the element to be driven, which increases its installation space as a result.

Furthermore, reference should be made to DE 10 2018 212 959 A1, which teaches a spindle drive in which the corresponding spindle nut is gimbal-mounted on a drive element. A similar approach was pursued in US 10 655 378 B2, in which a spindle nut is also mounted in a complex manner relative to a drive device in order to produce degrees of freedom of movement between the drive unit and the spindle.

However, all of the above-mentioned solutions from the prior art require a relatively high number of components and are accordingly costly and require a high level of maintenance. It is therefore the object of the present invention to provide a spindle drive which, with a simplified structure, enables a pivoting movement of its spindle relative to its drive unit and therefore has a reduced installation space requirement and is more cost-effective.

To achieve this object and to eliminate the above-described disadvantages of the prior art, a spindle drive is proposed according to the invention, comprising a drive unit, a spindle, a housing unit fixedly coupled to the drive unit, a bearing cage which is accommodated within the housing unit and is pivotable about a predetermined angular range with respect to a pivot axis, and a spindle nut which is mounted in the bearing cage at a fixed angle and is in threaded engagement with the spindle, wherein the spindle nut can be driven in rotation by the drive unit via a transmission arrangement.

Accordingly, in the spindle drive proposed according to the invention, the pivotability of the spindle relative to the drive unit is achieved by the spindle nut associated with the spindle being accommodated in a bearing cage which is pivotable relative to a housing, the housing unit in turn being fixedly coupled to the drive unit. Accordingly, pivoting the bearing cage relative to the housing unit results in pivoting of the spindle relative to the drive unit, and complicated hinge or gimbal arrangements can be dispensed with. Instead, the present invention enables a separation of a kinematically predetermined pivoting movement of a spindle by the drive itself, since the hinge enabling the pivoting movement is arranged between the spindle and the drive.

In this case, a deep groove ball bearing can preferably be provided for mounting the spindle nut in the bearing cage, which deep groove ball bearing is particularly suitable for this intended use in that it can absorb all acting forces in a suitable manner.

Furthermore, according to the invention, the transmission arrangement between the spindle nut and the drive unit can be formed by a worm gear having a worm shaft and a worm wheel, wherein the worm shaft can be coupled to the drive unit and the worm wheel can be coupled to the spindle nut. In particular, the worm wheel can be provided in one piece with the spindle nut by means of a thread on the radial outer side of said spindle nut, so that the worm nut can be directly acted upon by drive torques of the transmission arrangement via the worm shaft without any further interposed components. This design directly contributes to reducing the number of necessary components and saving installation space in the region of the spindle drive.

Furthermore, in such a design, the pivot axis of the bearing cage can coincide with the extension direction of the worm shaft, provided that no additional components are provided between the worm shaft and the spindle nut at this point.

Furthermore, it is advisable to completely accommodate the transmission arrangement within the housing unit, since, as a result, the components forming the transmission arrangement can be protected from ingress of contaminants and damage without the need for additional installation space for a corresponding casing.

For a similar purpose, the housing unit can be closed off, on the side thereof that faces away from the drive unit, by a housing cover which also contributes to protecting the spindle nut, the bearing cage and, optionally, additional components accommodated within the housing unit from external influences.

Furthermore, the pivot plane of the spindle can be perpendicular to a longitudinal direction of the drive unit, wherein, in particular in the embodiment just described in which the worm wheel is designed in one piece with the spindle nut, the worm shaft can be formed directly in an extension of a motor shaft of the drive unit, or can be integrally formed with said motor shaft, which, in this way, also extends along the longitudinal direction of the drive unit. Of course, embodiments are also conceivable in which the drive unit is at an angle to the pivot plane of the spindle, provided that a suitable gearing or a deflection apparatus for the drive rotation with an angular offset would be interposed.

In order to determine the angular range of pivotability of the bearing cage within the housing unit, the housing unit can in particular comprise an inner profile in the shape of an arc portion, along which the bearing cage runs within the housing unit with its outer profile. Therefore, in such a design, the bearing cage has an outer shape which corresponds to this inner profile of the housing unit, enabling a pivoting movement between the respective end positions of the arc portion as a result. Alternatively, however, other means for determining and limiting the pivoting movement of the bearing cage within the housing unit could of course also be provided, in particular stops and the like which limit a range of movement of the bearing cage.

With regard to the design of the bearing cage, it can, for example, be constructed in two parts, wherein the two parts can be connected to one another in a state in which the spindle nut and optionally the bearing mentioned above are inserted therein. In this case, the corresponding connection of the two parts can be carried out either detachably and indirectly, for example by clips or screws, or directly and permanently, for example by laser or ultrasonic welding.

In order to be able to attach the spindle drive according to the invention to a higher-level structure for a relative movement of two components thereof, the spindle and the drive unit can also each be provided with connecting arrangements for mounting the spindle drive on this higher-level assembly. In this case, these can include, inter alia, simple hinge arrangements which in turn enable the spindle drive to pivot about a relevant hinge axis.

Furthermore, a free end of the spindle, for example the end thereof that is opposite the connecting arrangement just mentioned, can be accommodated in a funnel-shaped sleeve element which enables the pivoting movement of the spindle and protects it from external access and, as a result, from contaminants and the like.

Furthermore, it should be noted that the drive unit of the spindle drive according to the invention will generally be formed by an electric motor having a rotating motor shaft in a design which is known per se, and said drive unit can further optionally comprise a gearing, in particular a planetary gearing, and/or a braking device, in particular a friction brake.

As already indicated above, the present invention further relates to a door or panel arrangement for a vehicle, comprising a vehicle door or vehicle panel which is hinged on a vehicle body of the vehicle and is pivotable about a hinge axis, and to a spindle drive of the type just described, which is arranged between the vehicle body and the vehicle door or vehicle panel. In this case, the longitudinal direction of the drive unit, for example defined by its motor shaft, can be parallel to the hinge axis of the vehicle door, which enables a particularly space-saving installation of said drive unit.

Further features and advantages of the present invention will become more apparent from the following description of an embodiment thereof when considered together with the accompanying drawings. In the drawings, in detail:

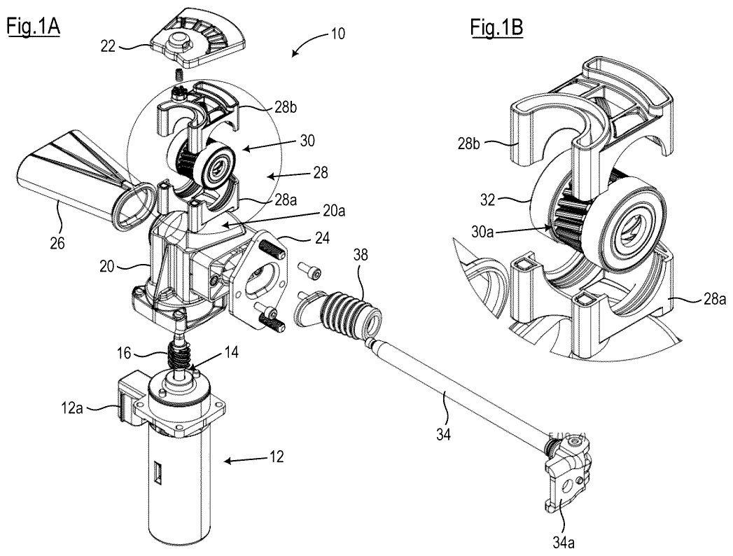

FIGS. 1A and 1B are an exploded view of a spindle drive according to the invention and an enlarged portion thereof;

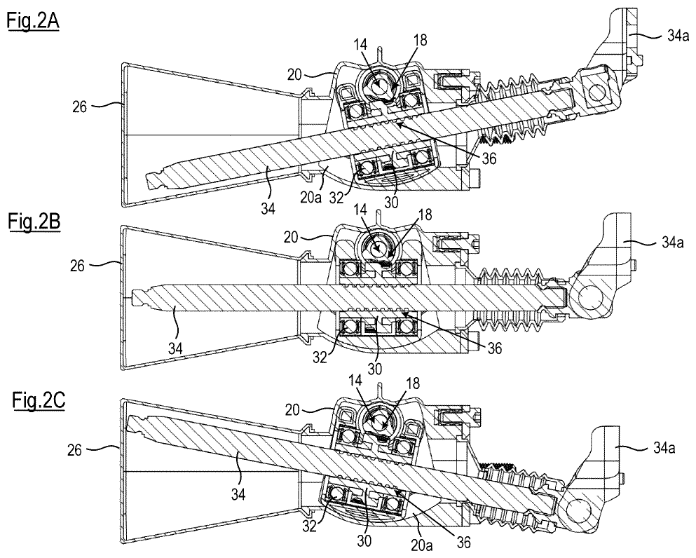

FIG. 2A to 2C are sectional views of the spindle drive from FIGS. 1A and 1B along the pivot plane of its spindle in three different pivoting states; and

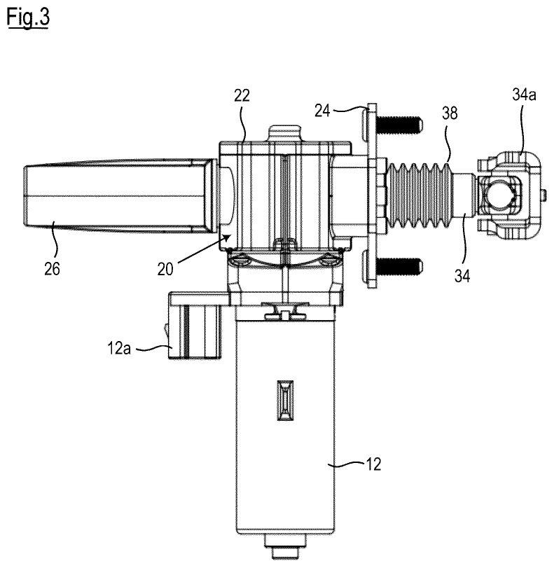

FIG. 3 is a side view of the spindle drive from FIG. 1A to 2C in an assembled state.

In FIG. 1A to 3, a spindle drive according to the invention is shown in different views and is generally denoted by the reference sign 10. This spindle drive 10 can, for example, form part of a door or panel arrangement for a vehicle (not shown further), in which the spindle drive is arranged between a vehicle door or vehicle panel and a vehicle body of the mentioned vehicle.

The spindle drive 10 in this case initially comprises a drive unit 12 in the form of an electric motor having a motor shaft 14, wherein the drive unit can comprise further components, for example a gearing (not shown further) or a brake. Furthermore, it should be noted that the drive unit 12 is associated with a connecting arrangement 12a, with which the spindle drive 10 can be attached to a higher-level assembly, i.e. in particular the vehicle body, or the vehicle door or vehicle panel in the mentioned special application of a use in a vehicle.

Furthermore, it can be seen in particular in FIG. 1A that a worm shaft 16 is attached directly on the motor shaft 14 for conjoint rotation, which worm shaft forms part of a transmission arrangement 18 which is described below and can be clearly seen in particular in FIG. 2A to 2C. As can also best be seen in FIG. 2A to 2C, the motor shaft 14, with its attached worm shaft 16, extends into a housing unit 20 which, in an assembled state of the spindle drive 10, which is shown in exploded view in FIG. 1A, is fixedly connected to the drive unit 12, for example by screwing.

An upper housing cover 22 and a lateral housing cover 24 can in turn be screwed to this housing unit 20, which housing covers close off the housing unit 20 at the top and at the side shown on the right in FIG. 2A to 2C. On the side of the housing unit 20 that is opposite the lateral housing cover 24, a funnel-shaped sleeve element 26 is further provided, which protects the spindle 34 described below from external influences in this region and, at the same time, enables it to pivot relative to the housing unit 20.

Furthermore, it should be noted that the housing unit 20 has an interior space having an inner profile 20a which is formed in the shape of an arc portion and can be clearly seen in FIG. 1A and 2A to 2C. A bearing cage 28 is now positioned in this inner profile 20a, which bearing cage is formed in two parts from a first and a second cage part 28a and 28b which are fixedly or detachably connected to one another in an assembled state.

This bearing cage 28 is designed with regard to its outer contour such that it can pivot within the inner profile 20a of the housing unit 20 by a predetermined angular amount about an axis which corresponds to the extension direction of the motor shaft 14, this pivot angle in the embodiment shown here being, for example, approximately ±12 degrees.

Within the bearing cage 28, a spindle nut 30 is now accommodated together with a deep groove ball bearing 32 such that the spindle nut is rotatable relative to the bearing cage 28, but is fixed in the axial direction. In this case, it can also be seen that the spindle nut 30 has a thread 30a on its outer side, which acts as a worm wheel for the worm shaft 16 on the motor shaft 14 of the drive unit 12. Accordingly, by operating the motor of the drive unit 12 and thus rotating the worm shaft 16, a rotation of the spindle nut 30 within the bearing cage 28 can be caused directly, this driving of the spindle nut 30 being possible in all pivoting positions of the bearing cage 28 relative to the housing unit 20.

This can be seen in particular in FIG. 2A to 2C, which show respective end positions of the pivoting movement of the bearing cage 28 within the housing unit 20, and a central position. In this case, it can also be seen that the three states from FIG. 2A to 2C each correspond to a different stroke state of a spindle 34 which is guided within the spindle nut 30 and is in threaded engagement with said spindle nut via a cooperating thread pair 36.

Accordingly, the pivoting movement shown in FIG. 2A to 2C can compensate for kinematics predetermined by the two higher-level components and their connection, which components are coupled via the already-mentioned connecting arrangement 12a to the drive unit 12 and to a second connecting arrangement 34a at the end of the spindle 34 shown on the right in FIG. 2A to 2C.

Finally, it should be noted that the spindle drive 10 further comprises a flexible sleeve element 38, by means of which the spindle 34 is guided out of the housing unit 20 on the side shown on the right in FIG. 2A to 2C, and which also prevents an ingress of contaminants or the like into the housing unit 20 at this point.

Accordingly, the spindle drive 10 according to the invention that is shown here, in a simple and compact manner, allows pivoting of the spindle 34 relative to the drive unit 12 and, as a result, a pivoting trajectory which is predetermined by kinematics of external components and directly correlates to the current stroke position of the spindle 34.

1. Spindle drive, comprising:
a drive unit;
a spindle;
a housing unit fixedly coupled to the drive unit;
a bearing cage which is accommodated within the housing unit and is pivotable about a predetermined angular range with respect to a pivot axis; and
a spindle nut which is mounted in the bearing cage at a fixed angle and is in threaded engagement with the spindle, wherein the spindle nut can be driven in rotation by the drive unit via a transmission arrangement.

2. Spindle drive according to claim 1,
wherein a deep groove ball bearing is provided for mounting the spindle nut in the bearing cage.

3. Spindle drive according to claim 1
wherein the transmission arrangement is formed by a worm gear having a worm shaft and a worm wheel, wherein the worm shaft is coupled to the drive unit and the worm wheel is coupled to the spindle nut.

4. Spindle drive according to claim 3,
wherein the worm wheel is provided in one piece with the spindle nut by means of a thread on the radial outer side of said spindle nut.

5. Spindle drive according to claim 3,
wherein the pivot axis of the bearing cage coincides with the extension direction of the worm shaft.

6. Spindle drive (10) according to claim 3,
wherein the extension direction of the worm shaft coincides with a longitudinal direction of the drive unit.

7. Spindle drive according to claim 1
wherein the transmission arrangement is completely accommodated within the housing unit.

8. Spindle drive according to claim 1,
wherein the housing unit is closed off, on the side thereof that faces away from the drive unit, by a housing cover.

9. Spindle drive according to claim 1,
wherein the pivot plane of the spindle is perpendicular to a longitudinal direction of the drive unit.

10. Spindle drive according to claim 1,
wherein the angular range of pivotability of the bearing cage within the housing unit is determined by an inner profile of the housing unit in the shape of an arc portion, along which the bearing cage runs with its outer profile.

11. Spindle drive according to claim 1,
wherein the bearing cage is constructed in two parts, wherein the two parts can be connected to one another in a state in which the spindle nut is inserted therein.

12. Spindle drive according to claim 1,
wherein the spindle and the drive unit are each provided with connecting arrangements for mounting the spindle drive on a higher-level assembly.

13. Spindle drive according to claim 1,
wherein a free end of the spindle is accommodated in a funnel-shaped sleeve element.

14. Spindle drive according to claim 1,
wherein the drive unit comprises a gearing, and/or a braking device.

15. Door or panel arrangement for a vehicle, comprising:
a vehicle door or vehicle panel which is hinged on a vehicle body of the vehicle and is pivotable about a hinge axis; and
a spindle drive according to claim 1, which is arranged between the vehicle body and the vehicle door or the vehicle panel.

16. Door or panel arrangement according to claim 15,
wherein the longitudinal direction of the drive unit is parallel to the hinge axis of the vehicle door.
